(19) United States
(12) Patent Application Publication
(10) Pub. No.: US 2014/0373340 A1
(43) Pub. Date: Dec. 25, 2014

(54) NON-GRAIN-ORIENTED HIGHER-STRENGTH ELECTRICAL STRIP WITH HIGH POLARISATION AND METHOD FOR THE PRODUCTION THEREOF

(71) Applicant: voestalpine Stahl GmbH, Linz (AT)

(72) Inventors: Franz Dorninger, Katsdorf (AT); Roman Sonnleitner, Bad Hall (AT); Herbert Kreuzer, Linz (AT)

(21) Appl. No.: 14/344,952

(22) PCT Filed: Sep. 17, 2012
(86) PCT No.: PCT/EP2012/068276

§ 371 Date: Mar. 14, 2014

(30) Foreign Application Priority Data
Sep. 16, 2011 (DE) 102011053723.6

(51) Int. Cl. H01F 1/147; C21D 8/12; H02K 15/02; H01F 41/02

(52) U.S. Cl. CPC H01F 1/14766; H01F 41/0213; C21D 8/1244; H02K 15/02; C22C 38/54
USPC 29/598; 148/112; 148/307; 148/309; 29/602.1

(57) ABSTRACT

A higher-strength, non-grain-oriented electrical strip with high polarization, the electrical strip consisting of a steel alloy, wherein the limits of the following elements are maintained: Mn between 0.35 mass % and 0.65 mass %, Si between 2.0 mass % and 3.0 mass %, Al between 0.8 mass % and 1.4 mass %, and P between 0.14 mass % and 0.24 mass %; and a method for the production thereof.

### FIELD OF THE INVENTION

The invention relates to a higher-strength electrical strip with a high polarization and a method for producing the higher-strength electrical strip with a high polarization as well as the use thereof.

### BACKGROUND OF THE INVENTION

Stator and rotor stacks in electric motors and generators as well as lamination stacks of transformers are produced from so-called electrical strip. Electrical strip is a strip steel sheet, for example with thicknesses of between 0.1 mm and 2 mm.

This strip steel sheet is stamped into the required shapes and the individually stamped components are assembled into corresponding stacks, which are then processed to produce finished electric motors, generators, or transformers. In these stamping processes, in order to reduce waste, usually both the rotor parts and the stator parts are stamped out of the same sheet and therefore have correspondingly similar properties. If an iron core (stacked sheets) of this kind is used in a coil, then its ferromagnetic properties—which are preset or at the least prepared by the steel manufacturer so that they are set by the user through a finish annealing—increase the permeability and therefore also the magnetic flux density in the coil. As a result, it is possible to reduce the number of windings needed to achieve a required inductance.

Because the iron of the core is an electrical conductor, in a coil with an iron core through which alternating current is flowing, a current flows in a quasi-short-circuit is winding, which is referred to as eddy current. This eddy current is reduced if the core is not made out of a single piece of iron, but rather out of a stack of the above-described iron sheets.

Electrical strip should be easy to magnetize i.e. should achieve the required polarization J or induction (flux density) B even with a low field strength H. As a result, the winding currents and the amount of material required for the winding and core can be kept to a minimum.

It should also have a low core loss P, i.e. should convert only a small amount of electrical power into heat, in order to achieve a high efficiency and a structurally lightweight dissipation of heat.

In small machines, the most important selection criterion for the core material is the effective polarization, i.e. the highest possible induction should be produced at a particular field strength. With increasing power and duty cycles, the loss in electrical energy and thus the problem of heat dissipation are of increasing importance. In large machines, the core loss is therefore a decisive criterion.

Electrical strips of this kind are composed of a relatively soft steel material. Particularly in the production of motors and generators, it is of interest for the manufacturer to reduce the air gaps because this increases the magnetic effectiveness; on the other hand, particularly with very high speed motors and in particular generators, very powerful centrifugal forces occur. Particularly in generators, the rotors can be relatively large so that the moving masses can produce very powerful centrifugal forces. These very powerful centrifugal forces on the one hand result in the fact that a stretching occurs so that very narrow air gaps are difficult to implement and on the other hand, the powerful centrifugal forces can also result in a failure of the rotor material.

In order to counteract these problems, it is known from the prior art to provide electrical strip with higher strength properties.

In order to increase the strength properties of electrical strip, it is customary to work with aluminum/silicon alloy concepts. Such alloy concepts are known, for example, from JP 2010090474 A, in which a relatively high silicon content is used. A general overview is provided by a paper from the “4th International Conference on Magnetism and Metallurgy,” WMM '10, Freiburg, Germany, “Magnetic and Mechanical Properties of Newly Developed High-Strength Non-Oriented Electrical Steel,” pages 277 through 281.

In addition, EP 2031 079 A1 has disclosed a high-strength electromagnetic steel strip and a method for the production thereof. This document has disclosed that copper increases the degree of recrystallization; the content should be less than 0.1 mass %, in particular less than 0.01 mass %.

The object of the invention is to produce a higher-strength electrical strip, which, in addition to a high strength, has very good magnetic properties and, in comparison to high-silicon- or high-aluminum-alloyed electrical strip, has high polarization values.

Another object of the invention is to create a method for producing a strip.

### SUMMARY OF THE INVENTION

The strengths described here lie in the following ranges:

Reh (transverse to the rolling direction): 400 MPa-650 MPa, in particular 420-620 MPa Rm (transverse to the rolling direction): 500 MPa-700 MPa, in particular 520 to 650 MPa

According to the invention, the polarization at 5000 A/m (J50) here should achieve the following minimum value, regardless of the thickness of the material and the strength:

J50>1.65 T

The core losses depend on the sheet thickness and can, for example, be expressed as follows for the following standard thicknesses (for all strength ranges):
Thickness of 0.35 mm: 2.3<P15<6 W/kg
Thickness of 0.5 mm: 2.5<P15<7 W/kg
Thickness of 0.65 mm: 3<P15<8 W/kg
Thickness of 1 mm: 4.5<P15<12 W/kg

The hardening mechanism in the invention is based on so-called solid solution hardening. In the prior art, silicon is used for solid solution hardening; the hardening effect of silicon, however, is limited and amounts to approximately +70 MPa per added mass % of silicon. The effect is achieved in that in the cubic body centered lattice of a fully ferritic electrical sheet, the silicon atoms sit on the lattice, i.e. substitute for iron.

Wherever contents are given below, these are understood to always be in mass %.

By contrast with the usual alloy concepts, according to the invention, an alloy concept with phosphorus is preferred, whose solid solution hardening effect per added mass % of phosphorus is significantly greater than that of silicon or aluminum. Alloying with silicon and aluminum does in fact have the advantage that by increasing the specific resistance, the core losses are reduced, which has a positive effect on the magnetic properties, but at the same time, the polarization values decrease, thus degrading the magnetic properties. Tests with a variation of the elements silicon, aluminum, manganese, and phosphorus have shown that only the addition of phosphorus increases the strength values, reduces the core losses, and does not negatively influence the polarization values.

The following linear relationships have been ascertained between the alloy elements and the annealing temperature and the magnetic and mechanical properties for material with a thickness of 0.5 mm under the conditions indicated below:

Tensile strength Rm (MPa):

Rm(MPa)=556+C*2438+Si*76.3+Mn*46.3+P*341+Al*33.03−T*0.311

This linear combination makes it possible to explain 95.6% of the variability in the target value Rm (R̂2=0.956).

The unexplained, random error is normally distributed at σ=7.27.

The prediction formula is valid provided that the influencing values meet the following conditions:
C carbon in wt %: 0.002<=C<=0.008
Si silicon in wt %: 0.5<=Si<=3.2
Mn manganese in wt %: 0.2<=Mn<=0.65
P phosphorus in wt %: 0.01<=P<=0.18
Al aluminum in wt %: 0.1<1.3
T annealing temperature in ° C.: 800<=T<=980
Annealing duration in seconds: 60

Core losses P15 at 1.5 T and 50 Hz:

P15 (W/kg)=14.44+C*34.7−Si*0.355+Mn*0.413−P*1.893−Al*0.199−T*0.0111

This linear combination makes it possible to explain 87.9% of the variability in the target value P15 (R̂2=0.879).

The unexplained, random error is normally distributed at σ=0.246.

The prediction formula is valid provided that the influencing values meet the following conditions:
C carbon in wt %: 0.002<=C<=0.008
Si silicon in wt %: 0.5<=Si<=3.2
Mn manganese in wt %: 0.2<=Mn<=0.65
P phosphorus in wt %: 0.01<=P<=0.18
Al aluminum in wt %: 0.1<1.3
T annealing temperature in ° C.: 750<=T<=980
Annealing duration in seconds: 60
Polarization J50 at 5000 A/m:

J50(mT)=1.876+C*1.57−Si*0.021−Mn*0.046−Al*0.022+P*0.003−T*139*10−6

This linear combination makes it possible to explain 86.3% of the variability in the target value J50 (R̂2=0.863).

The unexplained, random error is normally distributed at σ=0.009.

The prediction formula is valid provided that the influencing values meet the following conditions:
C carbon in wt %: 0.002<=C<=0.008
Si silicon in wt %: 0.5<=Si<=3.2
Mn manganese in wt %: 0.2<=Mn<=0.65
P phosphorus in wt %: 0.01<=P<=0.18
Al aluminum in wt %: 0.1<1.3
T annealing temperature in ° C.: 750<=T<=980
Annealing duration in seconds: 60

Within the above-mentioned ranges and within the tolerances for the individual influencing values, the formula can be used for material with a thickness of 0.5 mm, but cannot be used for material with a different thickness (e.g. 0.35 mm or 0.65 mm) with the same coefficients. It is permissible, however, to use it to make a rough estimate for the influence of the individual alloy elements.

Example for using the formula:

Material with the composition:
C: 0.004 wt %
Si: 2.4 wt %
Al: 1.0 wt %
Mn: 0.5 wt %
P: 0.01 wt %
   at an annealing temperature of 980° C. achieves the following values according to the formula:
P15: 2.83 W/kg
J50: 1.651 T
Rm: 504 MPa

An increase in Si by 1 wt % to 3.4 wt % while simultaneously keeping the other elements the same results in the following changes to the mechanical and magnetic properties:
P15: 2.48 W/kg: reduction by 0.355 W/kg
J50: 1.63 T: reduction by 0.021 T
Rm: 580 MPa: increase by 76 MPa

If the P content is then increased by 0.2 wt % to 0.21 wt % while simultaneously keeping the other elements the same, this yields:
P15: 2.45 W/kg: reduction by 0.379 W/kg
J50: 1.635 T: increase by 0.006 T
Rm: 572 MPa: increase by 68 MPa

The example shows that phosphorus and silicon, with the corresponding increase of the elements in the analysis, each decrease the core losses and increase (positively influence) the tensile strength to a similar degree, but P does not negatively influence the polarizations.

It was possible to ascertain the following influence of the alloy elements and the annealing temperature on the magnetic and mechanical properties for material with a thickness of 0.5 mm, under the conditions indicated below:

Tensile strength Rm (MPa):

Rm(MPa)=556+C*2438+Si*76.3+Mn*46.3+P*341+Al*33.03−T*0.311

Core loss P15 at 1.5 T and 50 Hz:

P15(W/kg)=14.44+C*34.7−Si*0.355+Mn*0.413−P*1.893−Al*0.199−T*0.0111

Polarization J50 at 5000 A/m:

J50 (mT)=1.876+C*1.57−Si*0.026−Mn*0.046−Al*0.0218+P*0.003−T*139*10−6

where
C carbon in wt %: <0.006
Si silicon in wt %: 0.3<Si<3.5
Mn manganese in wt %: 0.2<Mn<1
P phosphorus in wt %: 0.01<0.24
Al aluminum in wt %: 0.3<1.5
T annealing temperature in ° C.: 740-1000 (in particular 850-980° C.)
Annealing duration in seconds: 60

Within the above-mentioned ranges and within the tolerances for the individual values, the formula can be used for material with a thickness of 0.5 mm, but cannot be used for material with a different thickness (e.g. 0.35 mm or 0.65 mm) with the same coefficients. It is permissible, however, to use it to make a rough estimate for the influence of the individual alloy elements.

Example for using the formula:

Material with the composition:
C: 0.004 wt %
Si: 2.4 wt %
Al: 1.0 wt %
Mn: 0.5 wt %
P: 0.01 wt %
   at an annealing temperature of 980° C. achieves the following values according to the formula:
P15: 2.83 W/kg
J50: 1.639 T
Rm: 504 MPa

An increase in Si by 1 wt % to 3.4 wt % while simultaneously keeping the other elements the same results in the following changes to the mechanical and magnetic properties:
P15: 2.48 W/kg: reduction by 0.355 W/kg
J50: 1.613 T: reduction by 0.026 T
Rm: 580 MPa: increase by 76 MPa

If the P content is then increased by 0.2 wt % to 0.21 wt % while simultaneously keeping the other elements the same, this yields:
P15: 2.45 W/kg: reduction by 0.379 W/kg
J50: 1.635 T: increase by 0.006 T
Rm: 572 MPa: increase by 68 MPa

The example shows that phosphorus and silicon, with the corresponding increase of the elements in the analysis, each decrease the core losses and increase (positively influence) the tensile strength to a similar degree, but P does not negatively influence the polarizations.

In this case, tests have shown that with a P content of less than 0.14 mass %, the magnetic and mechanical properties required according to the invention are not achieved over the entire range of values. Tests have shown that with a P content of greater than 0.24 mass %, the material is no longer producible. In the P content range according to the invention of between 0.14 mass % and 0.24 mass %, it has turned out that not only is the material producible, but it is also possible to achieve the required mechanical and magnetic properties. It is known that different mechanisms are responsible for the embrittlement of material that occurs when alloying with Si or P. Silicon has an inherently embrittling action and by means of it, causes mainly cleavage fracturing. Phosphorus is known to be an element that primarily segregates at the grain boundaries and in so doing, weakens the grain boundaries, thus leading to grain boundary fracturing. The dissolved carbon primarily present at the grain boundaries, however, prevents phosphorus from weakening the grain boundaries. This effect leads to a surprisingly good ductility. With the combination of silicon, aluminum, and phosphorus according to the invention, the person skilled in the art would usually expect a high degree of brittleness, but this surprisingly does not occur. In addition, the positive effect of phosphorus in reducing eddy current losses is also known.

The invention has demonstrated that it is advantageous to work with an elevated reel temperature, in particular between approx. 600° C. and 750° C.

According to the invention, an electrical strip is adjusted so that the limits of the following elements are maintained:
Mn 0.35-0.65
Si 2.0-3.0
Al 0.8-1.4
P 0.14-0.24

In particular, the contents are as follows: carbon<0.005 mass %, silicon 2.2 mass %-2.6 mass %, manganese 0.4 mass %-0.6 mass %, phosphorus 0.14 mass %-0.19 mass %, sulfur<0.008 mass %, aluminum 0.9 mass %-1.3 mass %, nitrogen<0.0070 mass %, titanium<0.005 mass %, vanadium<0.01 mass %, chromium<0.05 mass %, niobium<0.02 mass %, and molybdenum<0.01 mass %, remainder: smelting-related impurities. With regard to certain elements and impurities, the attempt is made to achieve the following values:

| CR | Ni | Mo | Cu | V | Nb | Ti | Sn | Zr | As | B | Ca |
|---|---|---|---|---|---|---|---|---|---|---|---|
| max | max | max | max | max | max | max | max | max | max | max | max |
| 0.05 | 0.05 | 0.01 | 0.03 | 0.01 | 0.02 | 0.005 | 0.01 | 0.004 | 0.01 | 0.0005 | 0.004 |

As a result, a higher-strength electrical strip is achieved with an apparent yielding point Reh of between 400 MPa and 650 MPa and a tensile strength of between 500 MPa and 700 MPa, where at least the following polarization must be achieved:

J50 achieves a value>1.65 T independent of the strip thickness in the range between 0.2 mm and 1.5 mm, in particular between 0.3 mm and 1 mm)

The core losses depend on the sheet thickness and can, for example, be expressed as follows for the following standard thicknesses for all strength ranges:
Thickness of 0.35 mm: 2.3<P15<6 W/kg
Thickness of 0.5 mm: 2.5<P15<7 W/kg
Thickness of 0.65 mm: 3<P15<8 W/kg
Thickness of 1 mm: 4.5<P15<12 W/kg

In particular, the invention relates to a higher-strength electrical strip in which the electrical strip is composed of a steel alloy and the limits of the following elements are maintained:
Mn 0.35-0.65
Si 2.0-3.0
Al 0.8-1.4
P 0.14-0.24

For the achievement of the high polarization for all strength ranges, it is not necessary to carry out an optional hot strip annealing between the hot rolling and cold rolling.

### BRIEF DESCRIPTION OF THE DRAWINGS

The invention will be explained by way of example below in conjunction with the drawings. In the drawings:

FIG. 1 shows a micrograph of a steel strip that is not according to the invention and has a thickness of 0.5 mm;

FIG. 2 shows a strip according to the invention, with a thickness of 0.65 mm;

FIG. 3 shows a strip that is not according to the invention, with a thickness of 0.35 mm.

### DETAILED DESCRIPTION OF THE PREFERRED EMBODIMENTS

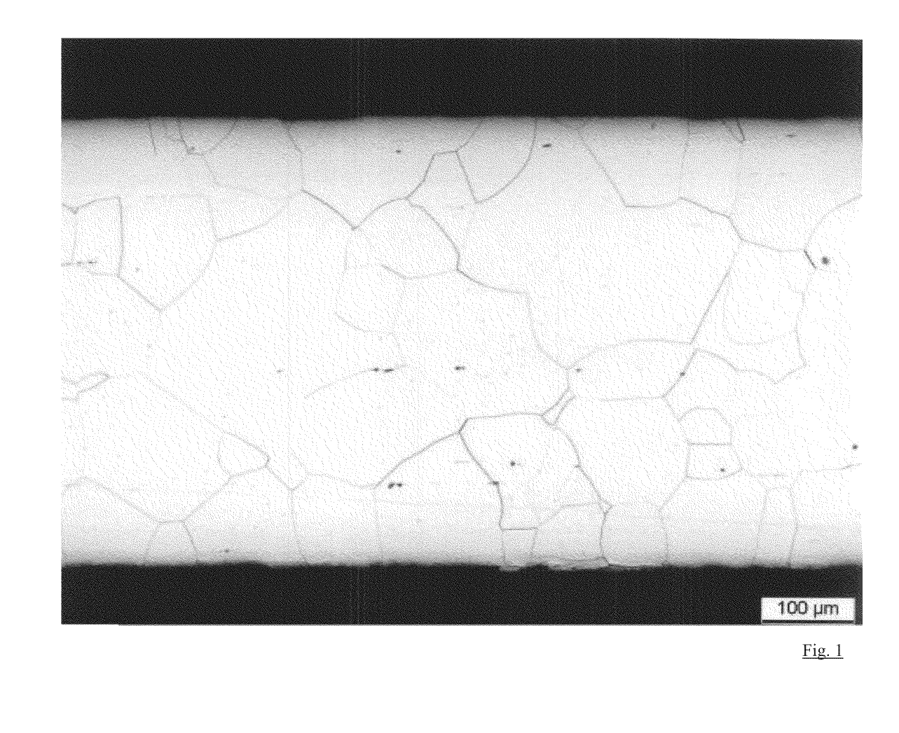

The figures show three different electrical steel strips; the example shown in FIG. 1 and referred to as strip 1 in the example below has a high silicon content and was annealed at 970° C. It has a coarse structure.

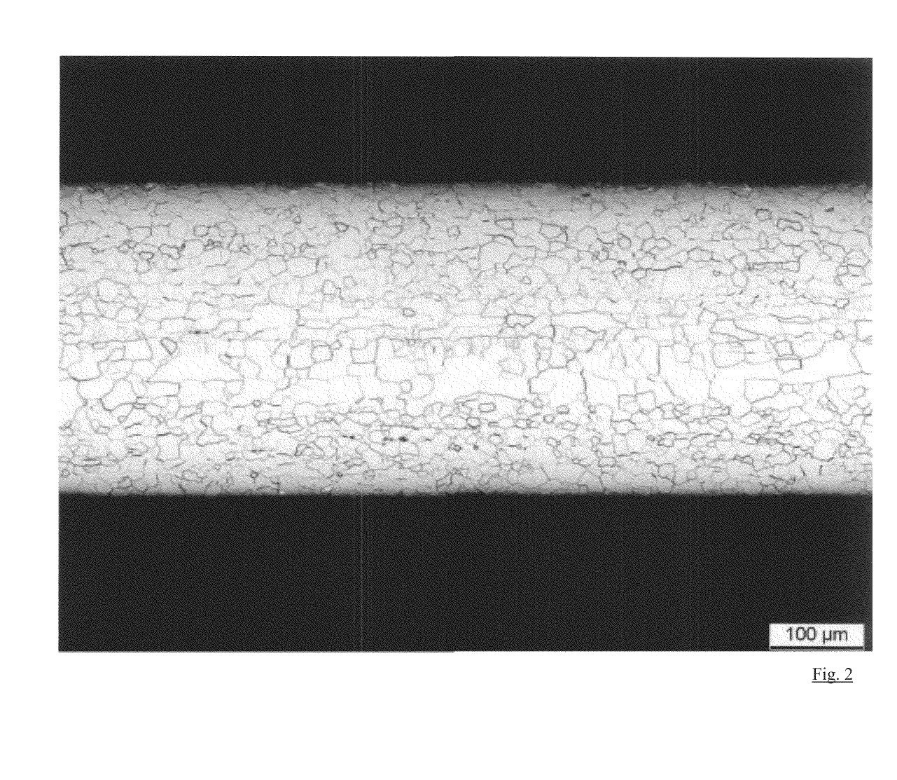

The strip 4 according to the invention shown in FIG. 2 has a thickness of 0.65 mm and a very high phosphorus content and is annealed at 850° C. It has a fine-grained, completely recrystallized structure.

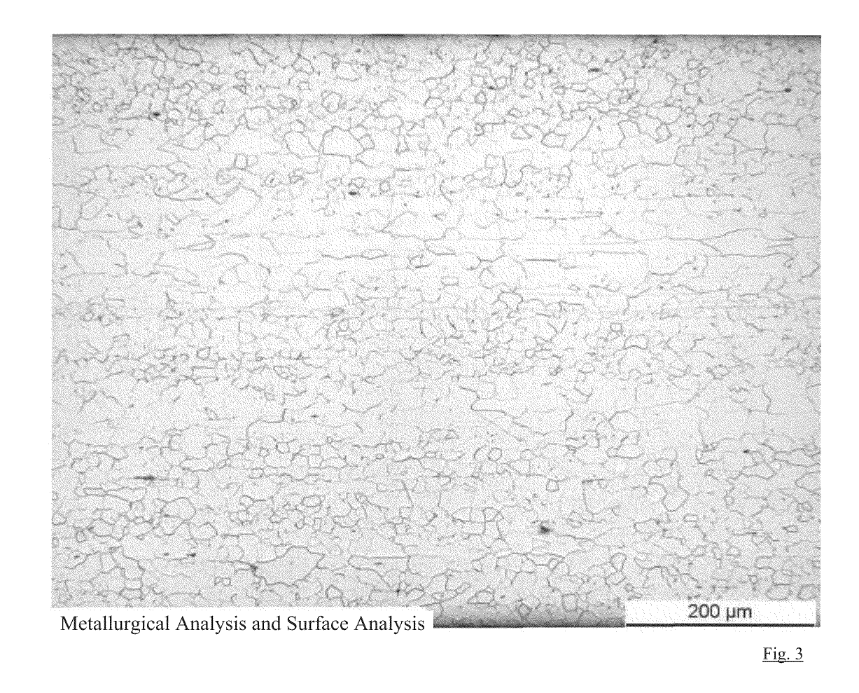

FIG. 3 shows the electrical steel strip number 5 from the examples, which is not according to the invention and has a thickness of 0.35 mm. It has a very high silicon content and was annealed at 740° C. and has a fine-grained, completely recrystallized structure.

At a high finish annealing temperature (970° C.), it is possible to achieve high strengths and low core losses even in comparison to high phosphorus. The achievable polarizations, however, are significantly lower and do not achieve the J50>1.65 T required according to the invention (example 1).

The lower the finish annealing temperature is selected to be, the higher the strengths with simultaneously good magnetic properties can be achieved by the high-phosphorus concept (examples 2 and 3). The fine grain-producing action of phosphorus is evident in strip 4 (FIG. 2), which enables achievement of a grain size comparable to strip 5, which is not according to the invention (FIG. 3) despite the significantly higher temperature (850° C. to 740° C.). At lower annealing temperatures (<800° C.), extremely high strengths can be achieved with a high phosphorus content.

The distinction between coarse and fine is defined as follows: a coarse structure has grains (the vast majority>50 μm, in particular>100 μm, whereas a fine structure has grains<50 μm. Naturally, grains can occasionally occur, which lie beyond these limits.

The invention will be explained in conjunction with exemplary embodiments; various compounds according to the invention are indicated; the abbreviations in the examples are defined as follows:
Reh=upper apparent yielding point
Rm=tensile strength
A80=breaking elongation
P15=core loss at 50 Hz and 1.5 T
J50=polarization at a field strength of 5,000 A/m

The following examples of production specimens should document the above-described relationships and the advantages of a high-phosphorus concept for achieving the high-strength electrical strip with high polarization values. The examples relate to 3 different material thicknesses (0.35 mm, 0.5 mm, and 0.65 mm) in different strength stages.

### EXAMPLE 1

ReH>400 MPa, Rm>500 MPa

The hot strip is continuously rolled into cold strip in a cold rolling process, producing a cold strip thickness of 0.5 mm. Then the material is annealed in a continuous finish annealing unit at a finish annealing temperature of 970° C. for 60 seconds.

Two strips with different analysis concepts were produced: strip 1 with an increased silicon content, strip 2 with an increased phosphorus content:

| | Strip 1 | Strip 2 |
|---|---|---|
| | (not according to | (according to |
| | the invention) | the invention) |
| C (wt %) | 0.0038 | 0.0048 |
| Si (wt %) | 3.22 | 2.35 |
| Al (wt %) | 0.98 | 1.04 |
| Mn (wt %) | 0.45 | 0.56 |
| P (wt %) | 0.014 | 0.15 |

With these parameters, it was possible to achieve the following properties:

Mechanical:

| | | | | |
|---|---|---|---|---|
| Reh (transverse) | 450 | MPa | 435 | MPa |
| Rm (transverse) | 570 | MPa | 553 | MPa |

| | | |
|---|---|---|
| A80 | 23.6% | 27.9% |

Magnetic:

| | | | | |
|---|---|---|---|---|
| P15: | 2.58 | W/kg | 2.64 | W/kg |
| J50: | 1.642 | T | 1.668 | T |

### EXAMPLE 2

ReH>480 MPa, Rm>550 MPa

The hot strip is continuously rolled into cold strip in a cold rolling process, producing a cold strip thickness of 0.65 mm. Then the material is annealed in a continuous finish annealing unit at a finish annealing temperature of 850° C. for 75 seconds.

Two strips with different analysis concepts were produced: strip 3 with an increased silicon content, strip 4 with an increased phosphorus content:

| | Strip 3 | Strip 4 |
|---|---|---|
| | (not according to | (according to |
| | the invention) | the invention) |
| C (wt %) | 0.0048 | 0.0044 |
| Si (wt %) | 2.83 | 2.34 |
| Al (wt %) | 0.98 | 1.02 |
| Mn (wt %) | 0.43 | 0.51 |
| P (wt %) | 0.012 | 0.149 |

With these parameters, it was possible to achieve the following properties:

Mechanical:

| | | | | |
|---|---|---|---|---|
| Reh (transverse) | 495 | MPa | 535 | MPa |
| Rm (transverse) | 590 | MPa | 620 | MPa |

| | | |
|---|---|---|
| A80 | 22.4% | 24.1% |

Magnetic:

| | | | | |
|---|---|---|---|---|
| P15: | 4.85 | W/kg | 5.14 | W/kg |
| J50: | 1.647 | T | 1.664 | T |

### EXAMPLE 3

ReH>550 MPa, Rm>600 MPa

The hot strip is continuously rolled into cold strip in a cold rolling process, producing a cold strip thickness of 0.35 mm. Then the material is annealed in a continuous finish annealing unit at a finish annealing temperature of 740° C. for 120 seconds.

Two strips with different analysis concepts were produced: strip 5 with an increased silicon content, strip 6 with an increased phosphorus content:

| | Strip 5 | Strip 6 |
|---|---|---|
| | (not according to | (according to |
| | the invention) | the invention) |
| C (wt %) | 0.0043 | 0.0041 |
| Si (wt %) | 3.25 | 2.39 |
| Al (wt %) | 1.01 | 1.05 |
| Mn (wt %) | 0.52 | 0.48 |
| P (wt %) | 0.011 | 0.193 |

With these parameters, it was possible to achieve the following properties:

Mechanical:

| | | | | |
|---|---|---|---|---|
| Reh (transverse) | 562 | MPa | 605 | MPa |
| Rm (transverse) | 635 | MPa | 652 | MPa |

| | | |
|---|---|---|
| A80 | 19.4% | 18.1% |

Magnetic:

| | | | | |
|---|---|---|---|---|
| P15: | 5.15 | W/kg | 5.04 | W/kg |
| J50: | 1.648 | T | 1.674 | T |

It should be noted that although the differences in the values between the strips that are not according to the invention and the strips that are according to the invention may sometimes not seem very high in the J50 range, they are in fact significant because even differences in the thousandth range are crucial here.

1. A higher strength, non-grain-oriented electrical strip with a high polarization, the electrical strip consisting essentially of a steel alloy in which the following limits of the following elements are maintained:
Mn 0.35 mass %-0.65 mass %
Si 2.0 mass %-3.0 mass %
Al 0.8 mass %-1.4 mass %
P 0.14 mass %-0.24 mass %.

2. The electrical strip according to claim 1, wherein the steel alloy further comprises a carbon content that is less than 0.05%.

3. The electrical strip according to claim 1, wherein the steel alloy comprises:
C<0.005 mass %,
Si 2.3 mass %-2.4 mass %,
Mn 0.48 mass %-0.53 mass %,
P 0.14 mass %-0.15 mass %,
S<0.008 mass %,
Al 1.0 mass %-1.1 mass %,
N<0.005 mass %,
Ti<0.005 mass %,
Vd<0.01 mass %,
Cr<0.02 mass %,
Nb<0.02 mass %,
Mb<0.008 mass %; and
a remainder comprising iron and smelting-related impurities.

4. The electrical strip according to claim 1, wherein, with regard to certain elements and impurities, the following values are maintained in the steel alloy:

| CR | Ni | Mo | Cu | V | Nb | Ti | Sn | Zr | As | B | Ca |
|---|---|---|---|---|---|---|---|---|---|---|---|
| max | max | max | max | max | max | max | max | max | max | max | max |
| 0.05 | 0.05 | 0.01 | 0.03 | 0.01 | 0.02 | 0.005 | 0.01 | 0.004 | 0.01 | 0.0005 | 0.004 |

5. The electrical strip according to claim 1, wherein the electrical strip has a strength Reh (transverse to a rolling direction) that is 400 MPa to 650 MPa.

6. The electrical strip according to claim 1, wherein the electrical strip has a strength Rm (transverse to a rolling direction) that is 500 MPa to 700 MPa.

7. The electrical strip according to claim 1, wherein the electrical strip has a polarization at 5,000 A/m (J50) that is J50>1.65 T regardless of thickness and strength.

8. The electrical strip according to claim 1, wherein the electrical strip has core losses as follows, depending on sheet thickness:
Thickness of 0.35 mm: 2.3<P15<6 W/kg
Thickness of 0.5 mm: 2.5<P15<7 W/kg
Thickness of 0.65 mm: 3<P15<8 W/kg
Thickness of 1 mm: 4.5<P15<12 W/kg

9. A method for producing the electrical strip according to claim 1, comprising setting a tensile strength Rm (MPa) using the following formula:
Rm(MPa)=556+C*2438+Si*76.3+Mn*46.3+P*341+Al*33.03−T*0.311.

10. The method according to claim 9, comprising setting a core loss P15 at 1.5 T and 50 Hz as follows:
P15(W/kg)=14.44+C*34.7−Si*0.355+Mn*0.413−P*1.893−Al*0.199−T*0.0111
wherein:
C carbon in wt %: 0.002<=C<=0.008
Si silicon in wt %: 0.5<=Si<=3.2
Mn manganese in wt %: 0.2<=Mn<=0.65
P phosphorus in wt %: 0.01<=P<=0.18
Al aluminum in wt %: 0.1<1.3
T annealing temperature in ° C.: 750<=T<=980
Annealing duration in seconds: 60.

11. The method according to claim 9, comprising setting a polarization J50 at 5,000 A/m as follows:
J50(mT)=1.876+C*1.57−Si*0.021−Mn*0.046−Al*0.022+P*0.003−T*139*10−6
wherein:
C carbon in wt %: 0.002<=C<=0.008
Si silicon in wt %: 0.5<=Si<=3.2
Mn manganese in wt %: 0.2<=Mn<=0.65
P phosphorus in wt %: 0.01<=P<=0.18
Al aluminum in wt %: 0.1<1.3
T annealing temperature in ° C.: 750<=T<=980
Annealing duration in seconds: 60
and wherein J50>1.65 T.

12. The method according to claim 9, comprising annealing the steel alloy at a temperature that is 700° C.; for 60 seconds to 200 seconds; Rm=500 MPa to 800 MPa; Reh=400 MPa to 700 MPa; and J50>1.63 T.

13. A method of using the electrical strip according to claim 1, comprising using the electrical strip to form rotor and stator lamination stacks in electric motors or generators or for lamination stacks of transformers.
